(19) United States
(12) Patent Application Publication
(10) Pub. No.: US 2008/0045076 A1
(43) Pub. Date: Feb. 21, 2008

(54) Clamp with spring contacts to attach flat flex cable (FFC) to a circuit board

(76) Inventors: Larry E. Dittmann, Middletown, PA (US); John David Williams, Sunnyvale, CA (US); William B. Long, Sunnyvale, CA (US); Tingbao Chen, Cupertino, CA (US)

Correspondence Address: NEOCONIX, INC.;c/o INTELLEVATE, LLC, P.O. BOX 52050, MINNEAPOLIS, MN, 55402, US

(21) Appl. No.: 11/788,123

(22) Filed: Apr. 19, 2007

Related U.S. Application Data
(60) Provisional application No. 60/794,035, filed on Apr. 21, 2006.

(51) Int. Cl. H01R 12/24

(52) U.S. Cl. 439/495; 248/74.2

(57) ABSTRACT

The present invention provides a clamp with spring contact elements to receive and secure a flat flex cable with exposed electrical traces to an electrical circuit such as on a printed circuit board. The clamp of the present invention has features for enhanced registration and alignment of exposed electrical traces on the flat flex cable to the spring contact elements in the clamp. Another aspect of the invention is the ability to connect high density contact arrays within the clamp to a circuit board via an array of contact pads on the opposite side of the substrate on which the spring contact elements are disposed. One exemplary application of the present invention is to connect a camera module in a cell phone to a printed circuit board or like electrical device in the phone.

### RELATED PATENT APPLICATIONS

This application claims the benefit, under 35 U.S.C. §120, of U.S. Provisional Application Ser. No. 60/794,035, entitled “Clamp with Spring Contacts or Electrical Traces to Attach Flat Flex Cable (FFC) to a Circuit Board,” of Larry E. Dittmann et al., filed on Apr. 21, 2006, which claims priority of U.S. patent application Ser. No. 11/265,205, entitled “Electrical Connector on a Flexible Carrier,” of John D. Williams, filed on Nov. 3, 2005, which issued as U.S. Pat. No. 7,114,961, and which is a continuation-in-part of U.S. patent application Ser. No. 10/412,729, entitled “Contact Grid Array System,” of John D. Williams, filed on Apr. 11, 2003, which issued as U.S. Pat. No. 7,056,131, which are all herein incorporated by reference.

This application is a continuation-in-part of Attorney Docket No. EPC-00024-CIP, entitled “Method and System for Batch Manufacturing of Spring Elements,” of Dirk Brown et al., filed on Apr. 18, 2007, which is a continuation-in-part of U.S. patent application Ser. No. 11/083,031, filed Mar. 18, 2005, which in turn is a continuation-in-part of U.S. patent application Ser. No. 10/412,729, filed Apr. 11, 2003. Attorney Docket No. EPC-00024-CIP is also a continuation-in-part of U.S. patent application Ser. No. 11/445,272, filed Jun. 2, 2006, which in turn is a continuation-in-part of U.S. patent application Ser. No. 10/412,729, filed Apr. 11, 2003, and is a continuation in part of U.S. patent application Ser. No. 10/731,213 filed Dec. 8, 2003. Attorney Docket No. EPC-00024-CIP is also a continuation-in-part of U.S. patent application Ser. No. 11/649,052 filed Jan. 3, 2007 which is a continuation of U.S. patent application Ser. No. 11/445,285 filed Jun. 2, 2006 which in turn is a continuation-in-part of prior U.S. patent application Ser. No. 10/412,729 filed Apr. 11, 2003 and U.S. patent application Ser. No. 10/731,213 filed Dec. 18, 2003. All of the above applications and patents are herein incorporated by reference in their entirety.

### BACKGROUND

### FIELD OF THE INVENTION

Flat Flex Cables (FFC) are used to connect electrical devices. This invention provides a clamp with spring contact elements to receive and secure a FFC with exposed electrical traces to an electrical circuit such as a PCB or circuit board. The clamp of the present invention has features for enhanced registration and alignment of exposed electrical traces on the FFC to the spring contact elements in the clamp. Another aspect of the invention is the ability to connect high density contact arrays within the clamp to a circuit board via an array of contact pads on the opposite side of the substrate on which the spring contact elements are disposed. One exemplary application of the present invention is to connect a camera module in a cell phone to a PCB or semiconductor or like electrical device.

### BACKGROUND OF THE INVENTION

Flat flex cable (FFC) is an existing product supplied by many vendors. Electrical connectors attached to FFC at one or both ends of the FFC connect the FFC to electronic components at either end of the FFC. For example, common applications in which FFC can be utilized are cell phones and flat panel displays. The scale of the FFC and connectors are application specific. The environment in which the FFC operates has an impact on the selection of materials for the FFC and the type of connectors at either end. FFC used in small scale environments require connectors with a small pitch. Existing connectors are not well-suited to reliably work in space constrained environments. It is desirable to eliminate the connector attached to the FFC and yet enable a separable electrical connection.

### BRIEF DESCRIPTION OF THE DRAWINGS

FIG. 1 is a perspective view of an open clamp on a circuit board, the clamp enclosing spring contacts mounted on a substrate within the clamp.

FIG. 2 is a schematic drawing of a FFC with bottom side traces or pads exposed ready to be inserted into a clamp that has spring contacts for making electrical connections to the FFC electrical traces or pads when the clamp is closed.

FIGS. 3a to 3c show different views of a spring contact array with electrical traces disposed on the bottom surface.

FIG. 4 is a side perspective view of a FFC inserted into a closed clamp.

FIGS. 5a and 5b illustrate an FFC connector with enhanced registration and cable retention features.

FIGS. 6a to 6e illustrate an exemplary stack-up with an FFC and an enhanced connector.

FIGS. 7a to 7e illustrate a locking mechanism for the lid of a FFC connector.

FIGS. 8a to 8e show a FFC connector with more than two contact rows providing a grid array option.

FIGS. 9a and 9b show an FFC with a grounding strip exposed on the top of the cable and inserted into an FFC connector.

FIGS. 10a to 10f illustrate exemplary spring contact array patterns that can be incorporated into the FFC connectors of the present invention.

FIGS. 11a to 11d are flowcharts showing the steps of an exemplary method for making the spring contact elements of a FFC connector of the present invention

FIGS. 12a and 12b illustrate a circuitized FFC connector that can be incorporated into the FFC connectors of the present invention.

### DETAILED DESCRIPTION

The present invention provides connectors for flat flex cables (FFCs) using spring contact arrays such as those described in commonly assigned U.S. patent application entitled “Method and System for Batch Manufacturing of Spring Elements,” of Dirk Brown et al., filed on Apr. 18, 2007, herein incorporated by reference, and methods for making the same. The connectors of the present invention allow for a reliable electrical connection to be made between a FFC and the electrical component to which a connection is desired.

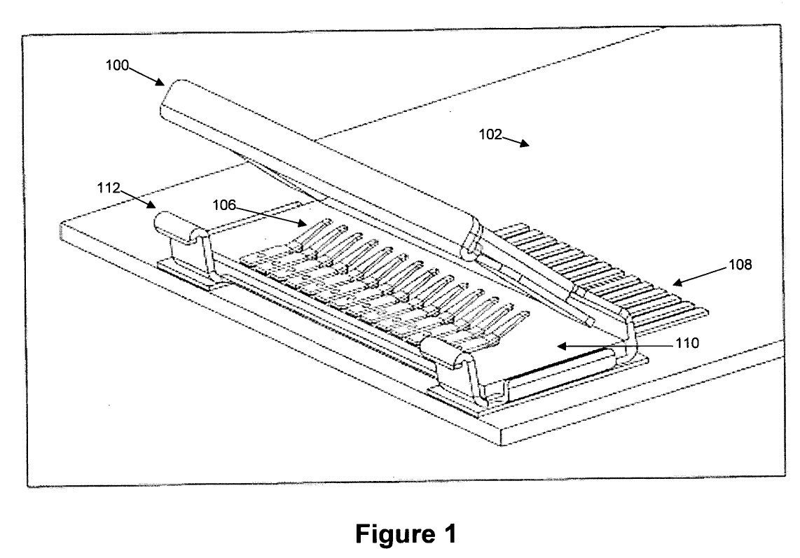

FIG. 1 shows an exemplary FFC connector mounted to a circuit board. A spring contact array 106 is disposed on a substrate 110 with connections from the base of the spring contact elements 106 to traces on the opposite side (not shown). These traces are connected mechanically and electrically to conductive strips 108 on circuit board 102 by conventional means such as surface mount solder or conductive adhesive. Spring contact array 106, while shown having a single row of spring contact elements oriented in the same direction, can have any number of contact elements sufficient to connect with a desired FFC and in any orientation.

Open clamp 100 is mounted on a circuit board 102 and has substrate 110 with spring contacts 106 disposed within it. The clamp is typically designed to meet a specific FFC dimensions and can be made by techniques widely used in the stamping and forming industry. The clamp material may be made from plastic, metal or other materials. It should be deformable to allow bending when closing the clamp lid into a locking position. Clamp 100 has locking tabs 112 to secure the lid in a closed position.

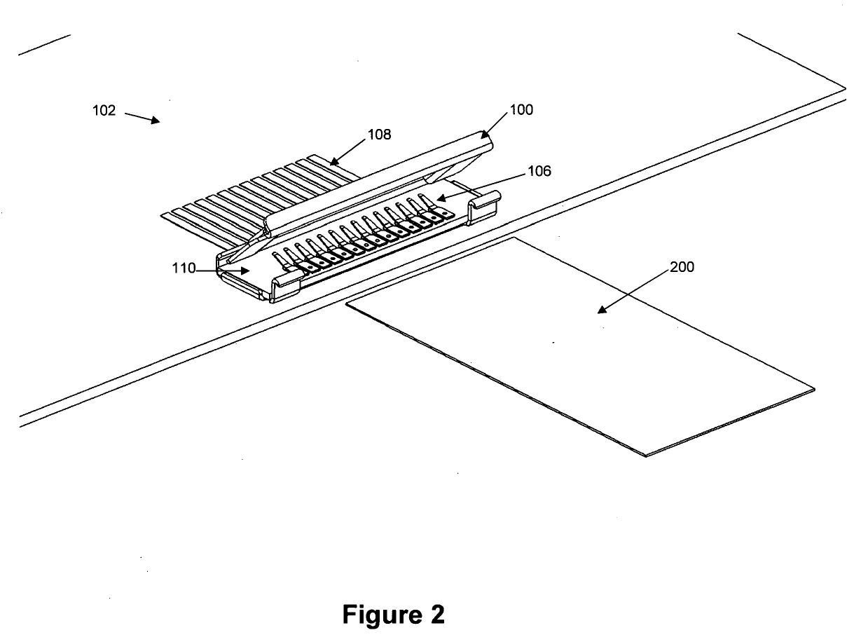

In FIG. 2, flat flex cable 200 with exposed electrical traces (not shown) on its bottom side is aligned to be inserted into the FFC connector illustrated in FIG. 1 to engage the spring contacts therein. The exposed electrical traces are enclosed within the FFC (not shown) and typically extend the length of the FFC to the opposite end such that an electrical connection can be made between devices. Once the FFC with its exposed electrical traces is inserted into the clamp, the exposed electrical traces make contact with spring contact elements 106 through traces on the opposite side and are mechanically and electrically connected to conducting strips 108 disposed on circuit board 102. The clamp is then closed into its locking position allowing for FFC 200 to remain securely attached to the circuit board and keep the exposed electrical traces and spring contacts in electrical contact.

An exemplary method for forming a FFC for use in this application can be accomplished by the following process. An insulating material of suitable mechanical and electrical properties is first selected. The material is typically a compliant or flexible carrier material with a conductive film adhering to its surface. Then a desired image etched into the conductive film forms a pattern of electrical traces that may terminated with pads or other connection means. The traces may be encapsulated with a protective covering that leaves only the pads or other connection means available for electrical connection.

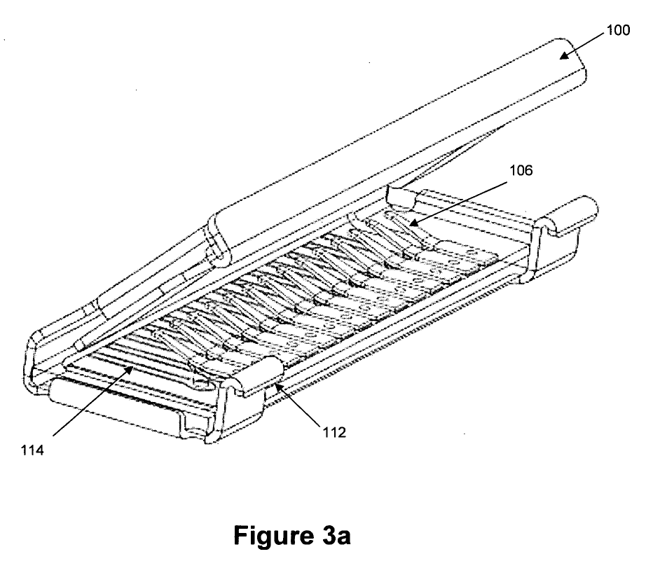

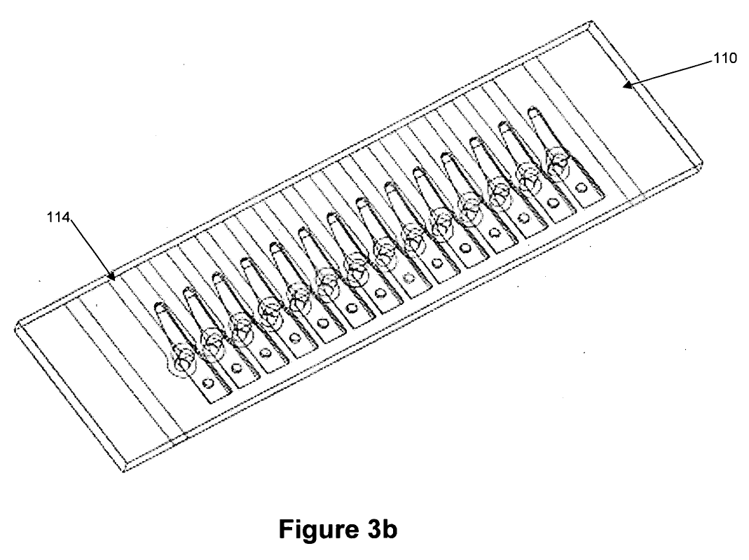

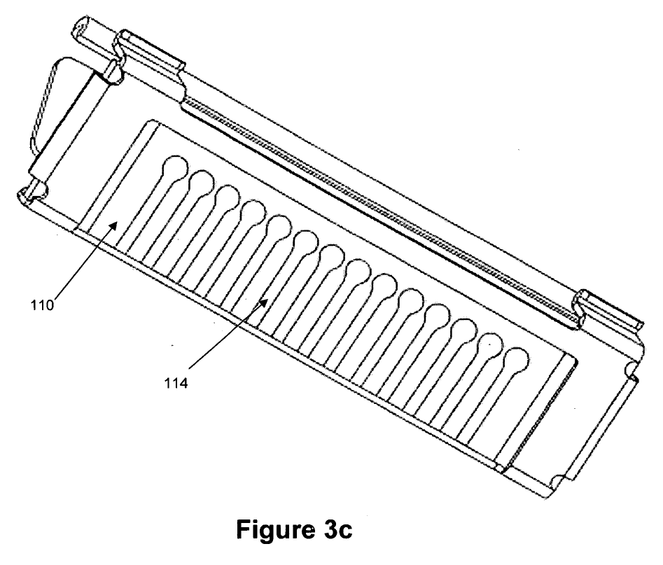

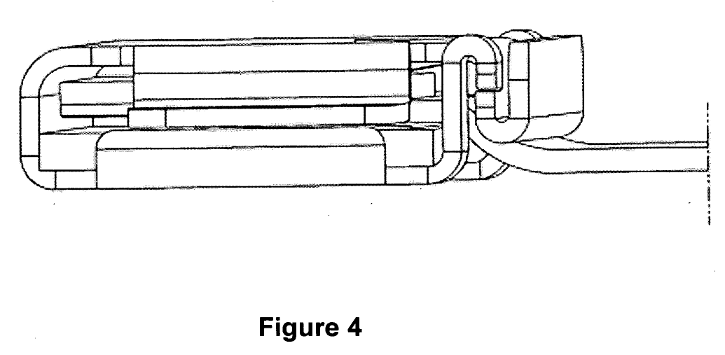

Referring to FIG. 3a, an open clamp 100 has spring contacts 106 mounted within it and electrical traces 114 connected to the spring contacts. The open lid of the clamp has a folded upper lip that locks shut as it slides over an inverted lower lip 112 of the clamp. Other securing means may be used keep the lid in a locked position and apply pressure to the FFC such that contact is made between the exposed electrical traces on the FFC and the spring contacts in the clamp. FIG. 3b shows a transparent bottom view of an array of spring contacts with connected electrical traces 114 mounted on a substrate 110 for insertion into a clamp. The base of contact elements 106 are connected through the substrate to electrical traces 114 on the bottom of the substrate where a contact is made with conducting strips 108 on a circuit board. The connection between electrical traces 114 and conducting strips 108 can be accomplished by means known in the art such as soldering or using conductive adhesives. Alternatively, spring contact elements can be formed on conducting strips 108 or on electrical traces 114 (on the bottom side of substrate 110) to allow for an electrical connection between the spring contact elements and the circuit board. FIG. 3c is a bottom view of a clamp, with a substrate mounted within, showing the exposed electrical traces that connect to spring contacts on the opposite side of the substrate. FIG. 4 shows a side view of the clamp in its fully closed position.

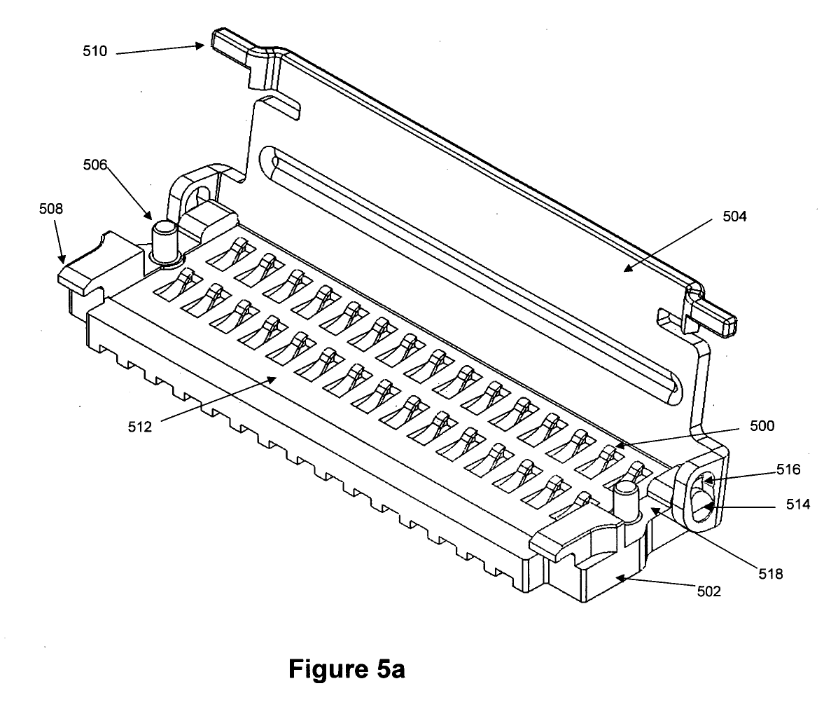

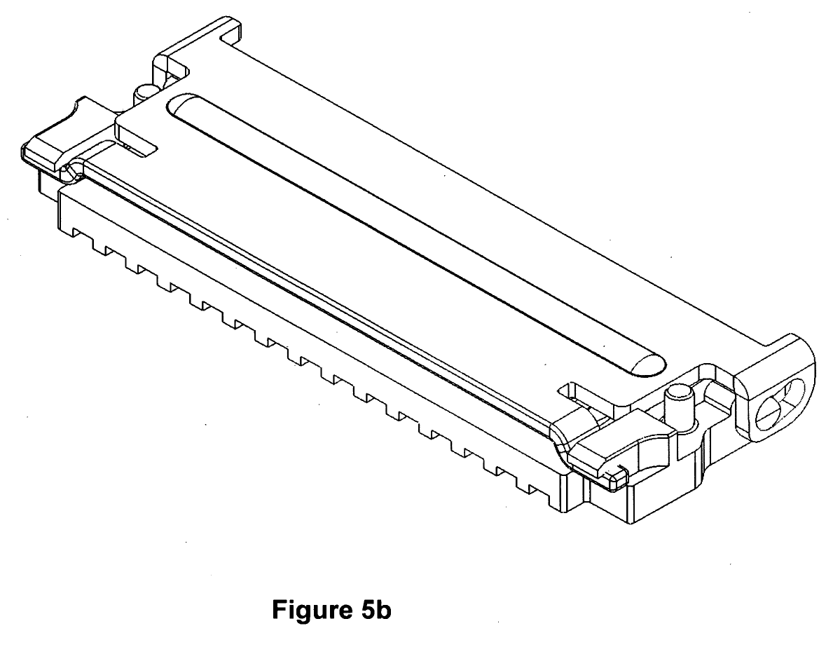

Another preferred FFC connector of the present invention is depicted in FIGS. 5a and 5b. FIG. 5a shows the connector in an open position. Spring contacts 500 are disposed on a substrate 512 located inside a base portion 502 of the connector. The base portion has dowels 506, or other alignment means, for aligning and securing a FFC in the connector. The base portion also has optional slots 518 for aligning and securing a FFC in the connector. Connector lid 504 is attached to base 502 by dowel pins 514 which sit in holes 516. As described in further detail below, lid 504 is attached such that when closed it can slide backwards so that retainer tabs 510 slide under retainer tab holders 508 and lock the lid in a closed position. FIG. 5b shows the connector in its fully closed position without a FFC attached thereto. While the connector of FIG. 5 is shown utilizing two dowel pins 506 or slots 518, any number of dowel pins or slots, or other alignment means can be used.

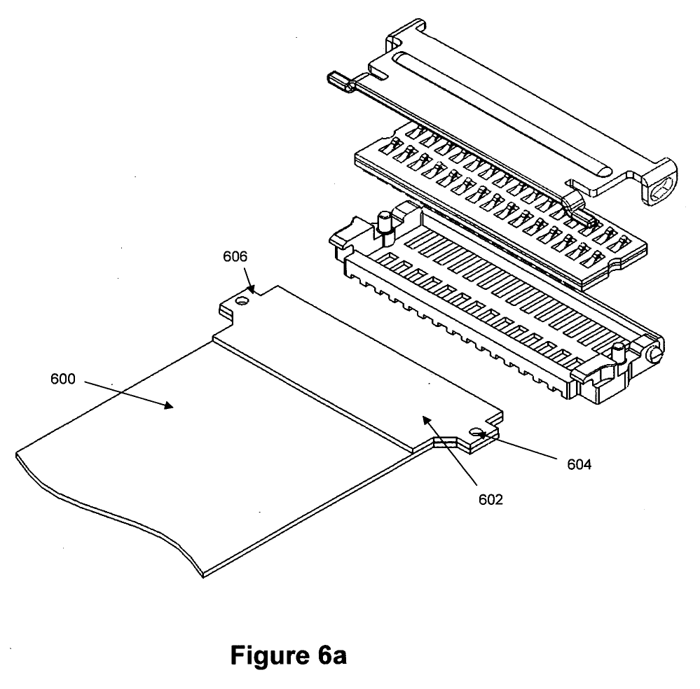

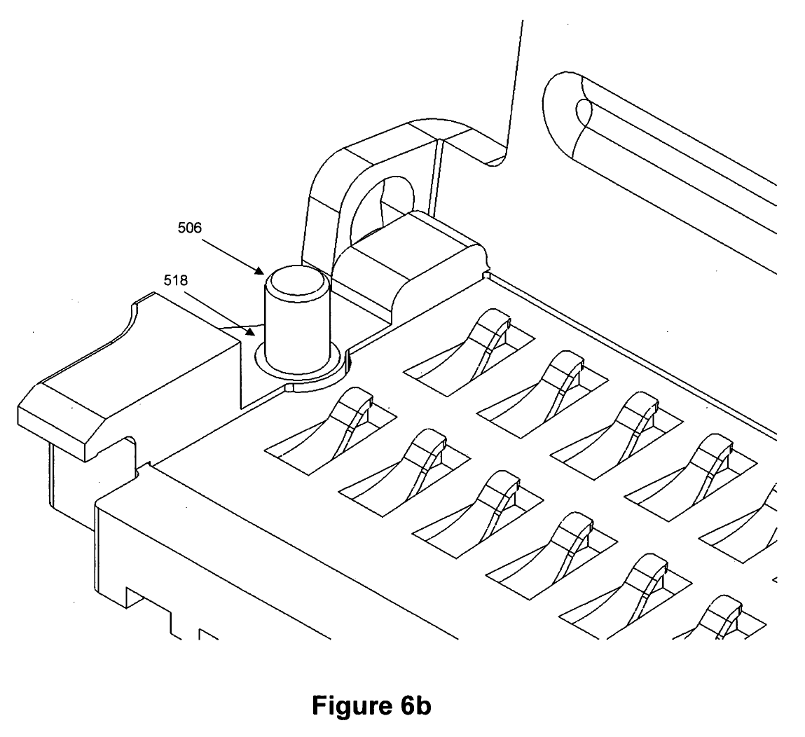

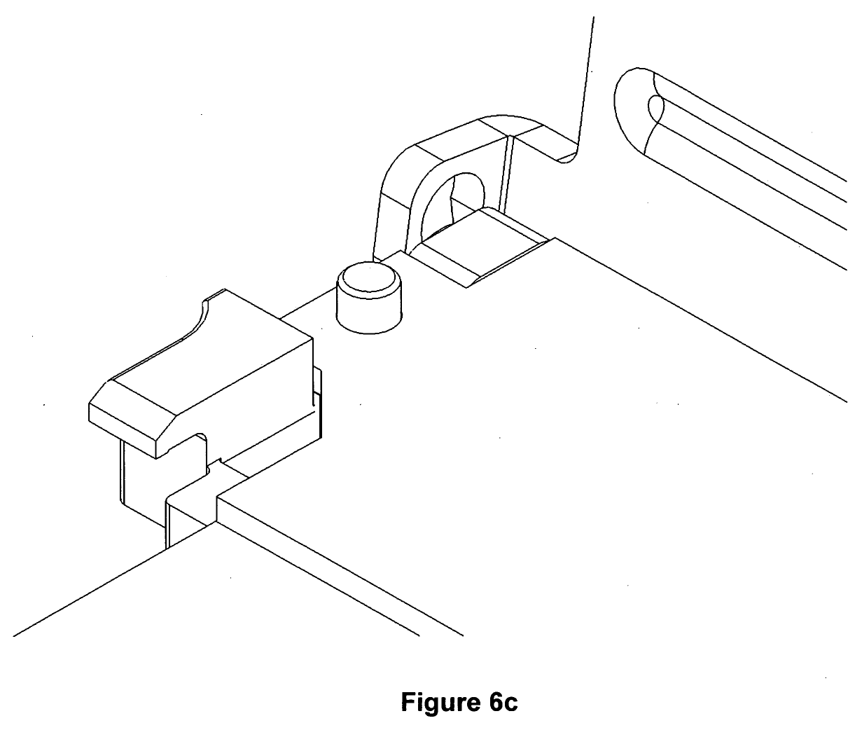

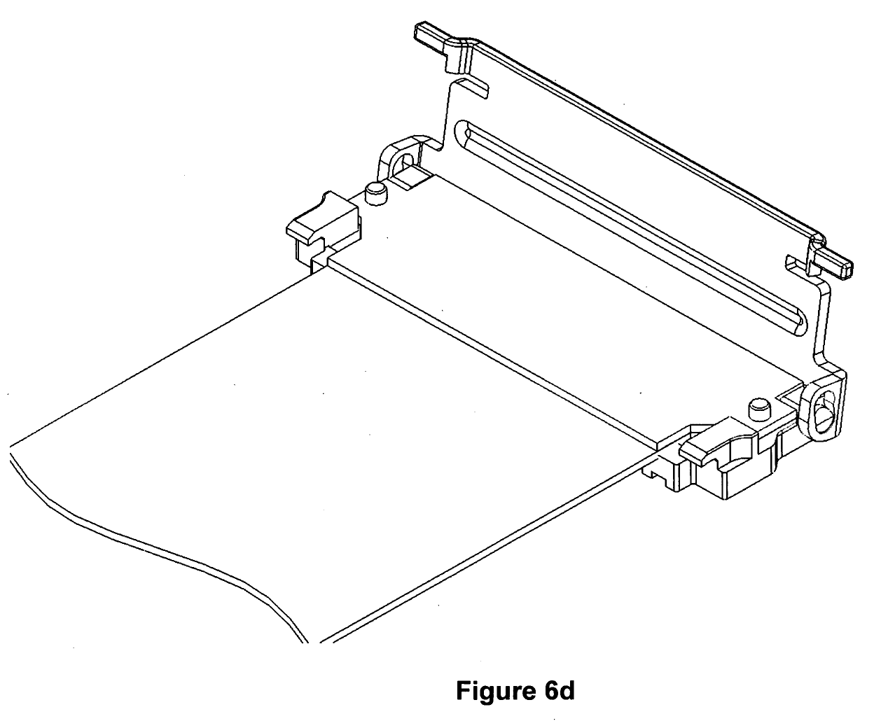

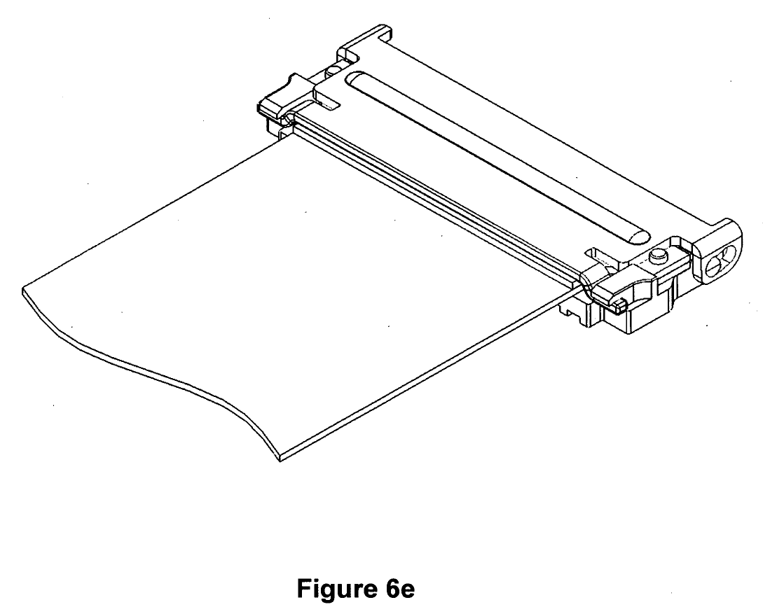

FIG. 6a is an exploded view of the connector illustrated in FIG. 5 with a FFC 600 designed for the connector. FFC 600 has an end portion 602 with exposed electrical traces on the bottom side to make contact with the spring contact elements of the connector. Holes 604 and tabs 606 are illustrated to show two exemplary alignment and securing means. FIG. 6b shows an exploded view of a dowel pin 506 for engaging FFC alignment holes 604 and slot 518 to engage FFC alignment tabs 606. FIG. 6c and 6d show FFC 600 sitting inside the connector with dowel pins 506 protruding through alignment holes 604 and alignment tabs 606 locked in slots 518. FIG. 6e shows the connector in a closed position with a FFC locked in place.

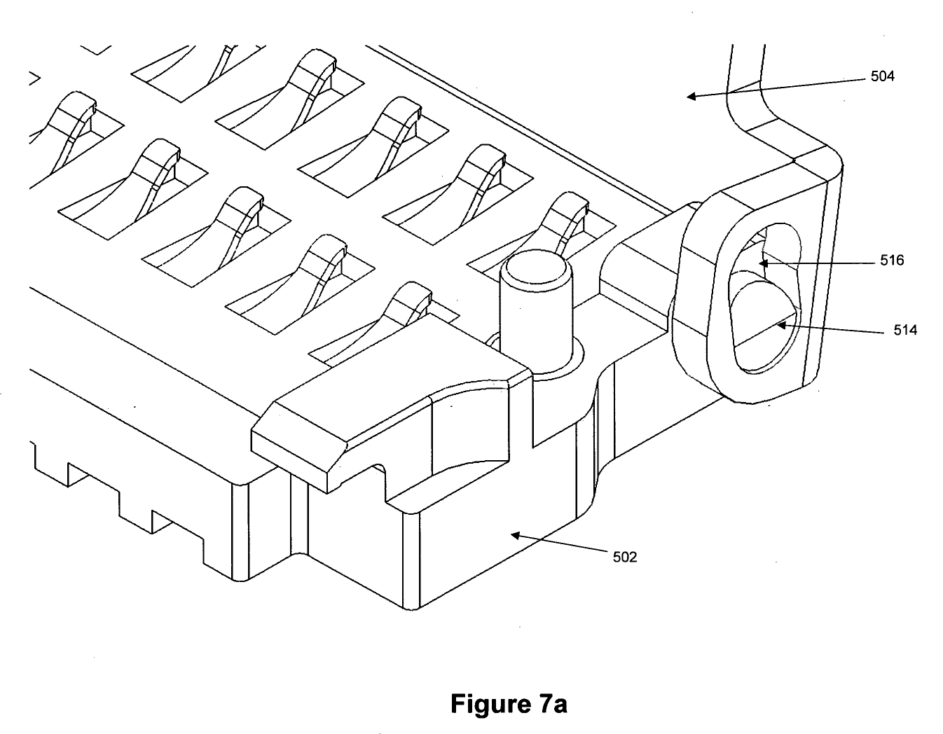

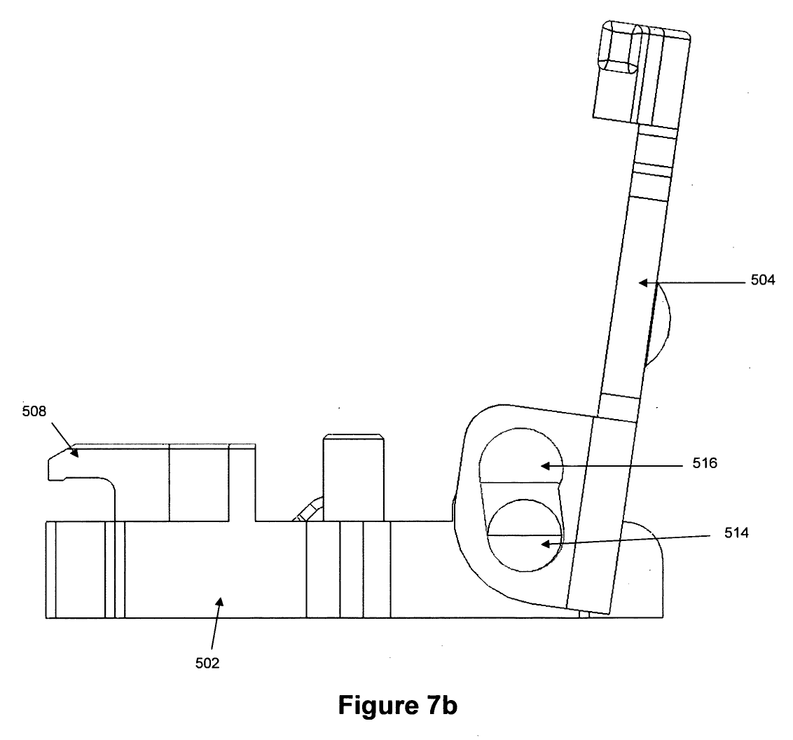

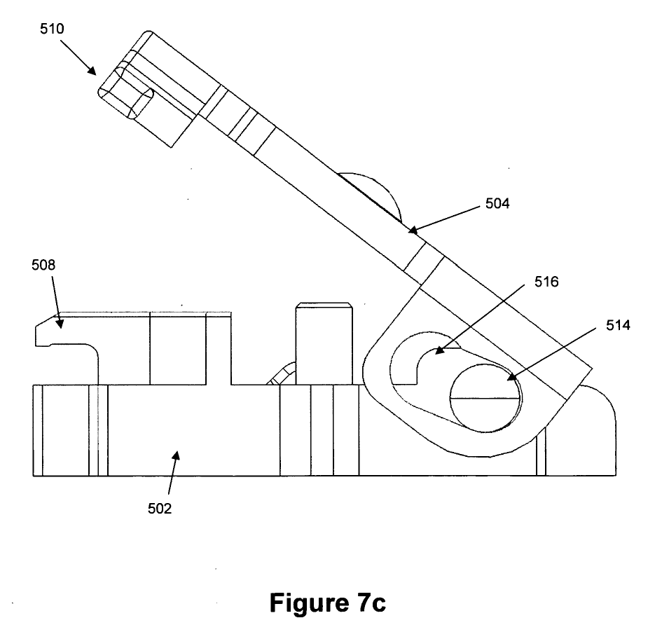

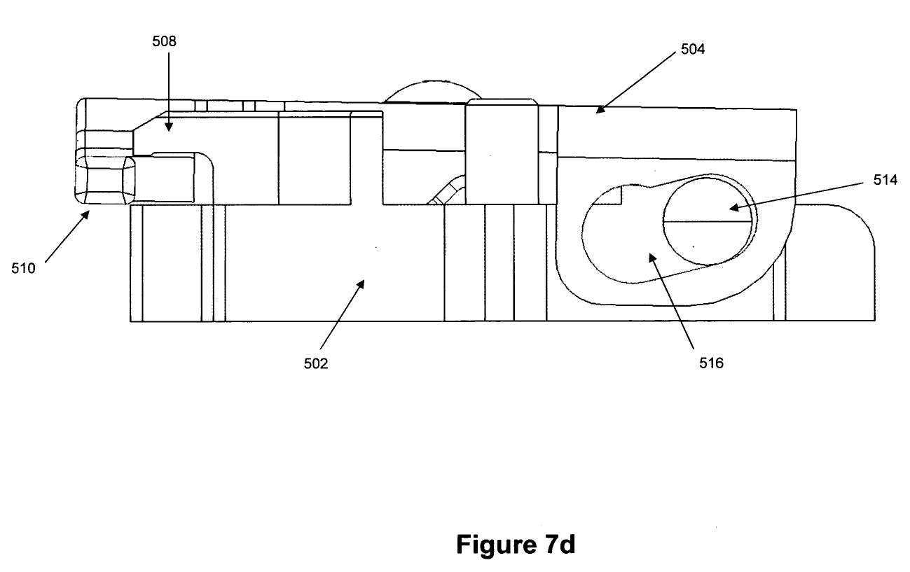

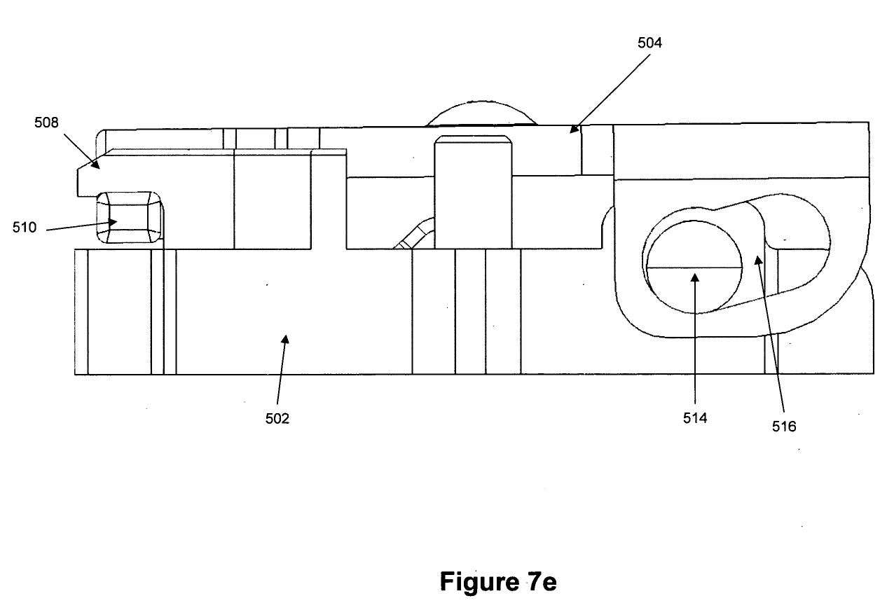

As described above, lid 504 is attached to base portion 502 of the connector by a dowel pin such that the lid can slide backwards in its closed position and remain locked. FIG. 7a shows a close-up view of dowel pin 514 which is attached to base 502 and sits in a hole 516 located on a side tab of lid 504. As shown in FIG. 7b, hole 516 is shaped such that when lid 504 is in its open position, dowel pin 514 sits in the semi-circular lower part of the hole. FIG. 7c illustrates lid 504 in a half-closed position. FIG. 7d shows the lid 504 in a closed unlocked position. In this position, the lid had been rotated to sit in a horizontal position, but has not yet been moved backwards. In FIG. 7e, lid 504 has been moved into a locked position in which dowel pin 514 occupies a second slightly larger semi-circular portion of hole 516 toward the front of the lid. In the fully closed and locked position, retainer tab 510 slides under retainer tab holder 508 and is secured by a lip on the retainer tab holder.

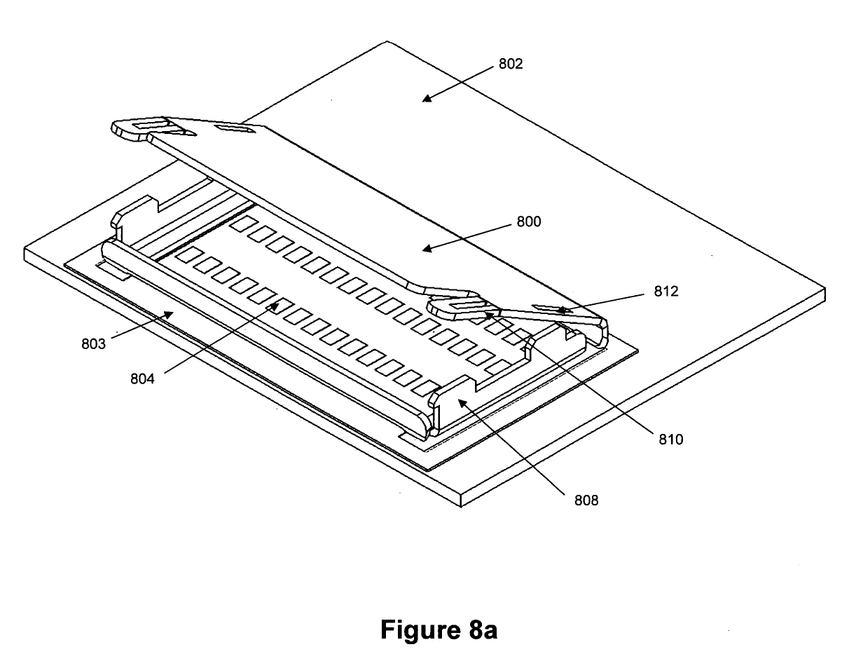

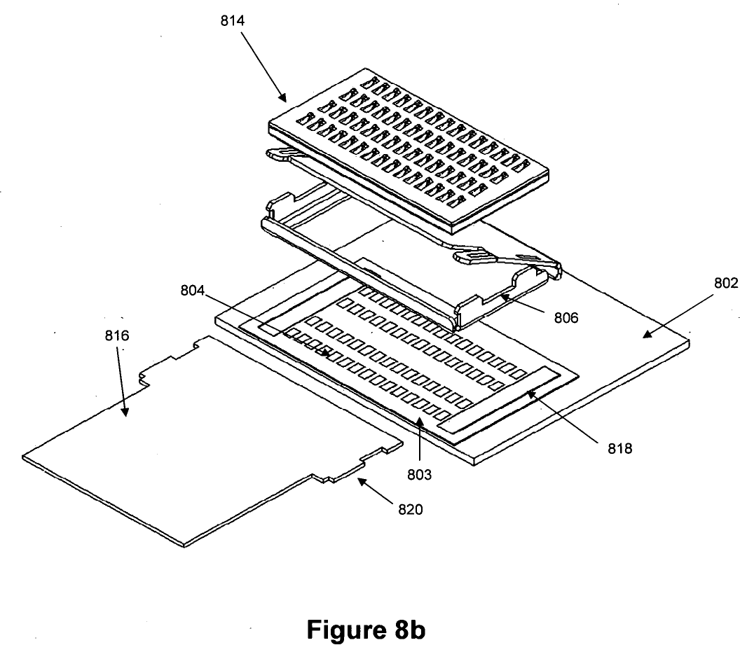

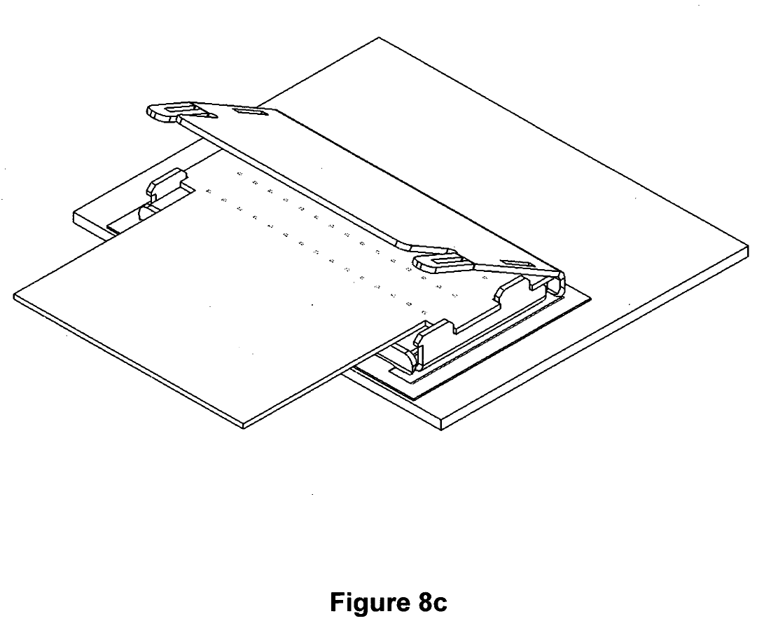

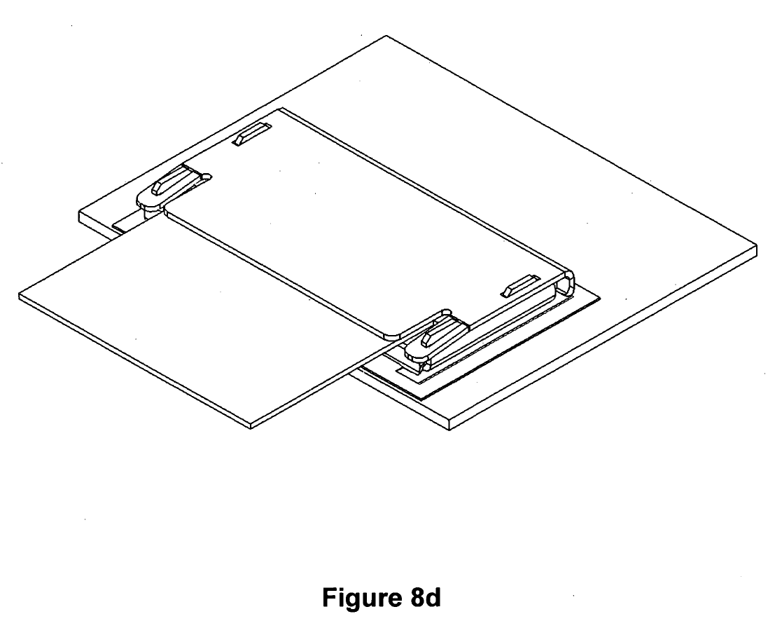

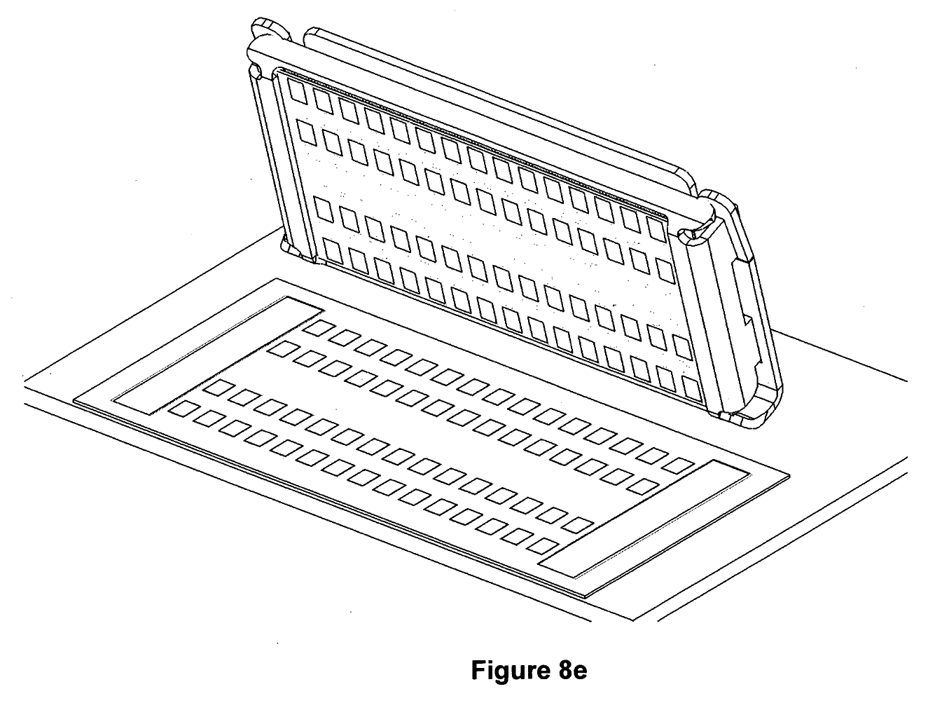

In FIGS. 8a to 8e, an alternate configuration is illustrated in which an array of contact pads is formed on a circuit board to electrically connect with the spring contact elements of an FFC connector. This configuration is herein referred to as an “array” FFC connector. Array FFC connectors allow for higher density of spring contacts than could be achieved in a FFC connector with one or two rows. The contact pads on an array FFC connector are attached to traces within the circuit board that transmit electrical signals to desired components. FIG. 8a shows open clamp 800 disposed on a contact array sheet 803 with contact pads 804 located thereon. Contact array sheet 803 is built on circuit board 802 and contact pads 804 are electrically connected to traces present in the board. Clamp 800 has retainer tabs 810 which lock onto retainer tab holders 808 when the clamp is in its fully closed position. The lid of clamp 800 optionally can contain holes 812 through which tabs present on the base of clamp 800 pass and align the lid with the base. FIG. 8b shows an exploded view of an array FFC connector with spring contact array 814 and FFC 816. As shown in this figure, FFC 816 has an end portion with an alignment means 820 that fits into alignment area 806 on clamp 800. The fit of alignment means 820 into alignment area 806 can be adjusted to provide a desired tolerance for lateral movement of the FFC in the connector. Contact array sheet 803 includes mounting strips 818. Clip 806 is attached to strips 818 by standard means such as solder or adhesive. Attachment of clip 806 to mounting strips 818 mechanically holds the array connector aligned with pads 804. Additionally strips 818 can be electrically connected to circuit board 802 to provide grounding of clip 806. This grounding provides a shield to prevent RF or EMI signals to couple to the connector traces or radiate from the signals within the connector. FIG. 8c shows the FFC sitting on top of the spring element array inside of open clamp 800. FIG. 8d shows the clamp in a closed position. FIG. 8e is bottom view of a connector array and the corresponding contact pads on the circuit board.

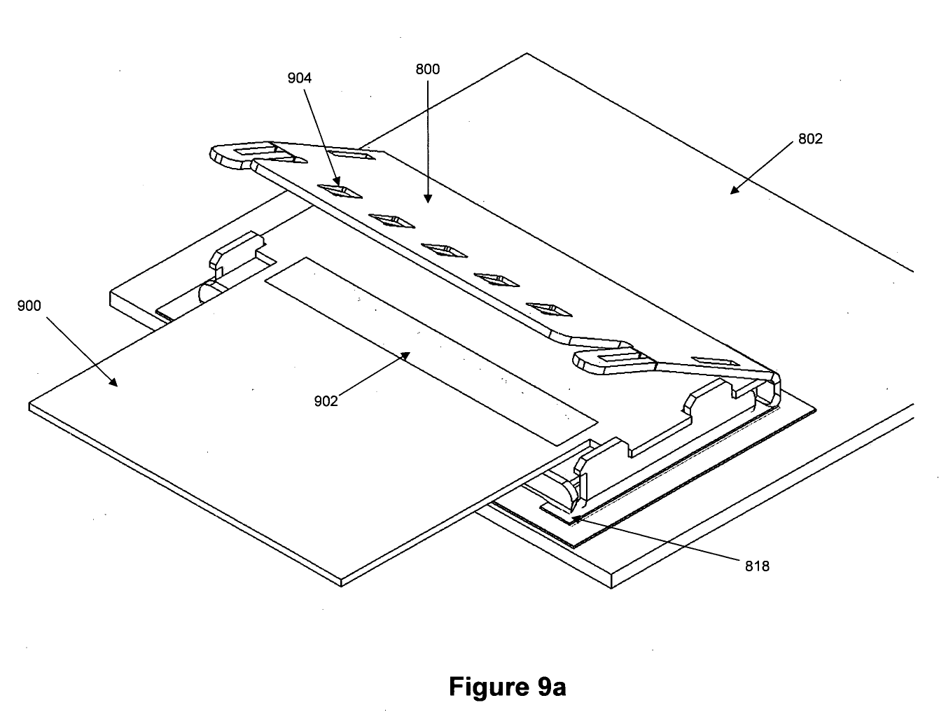

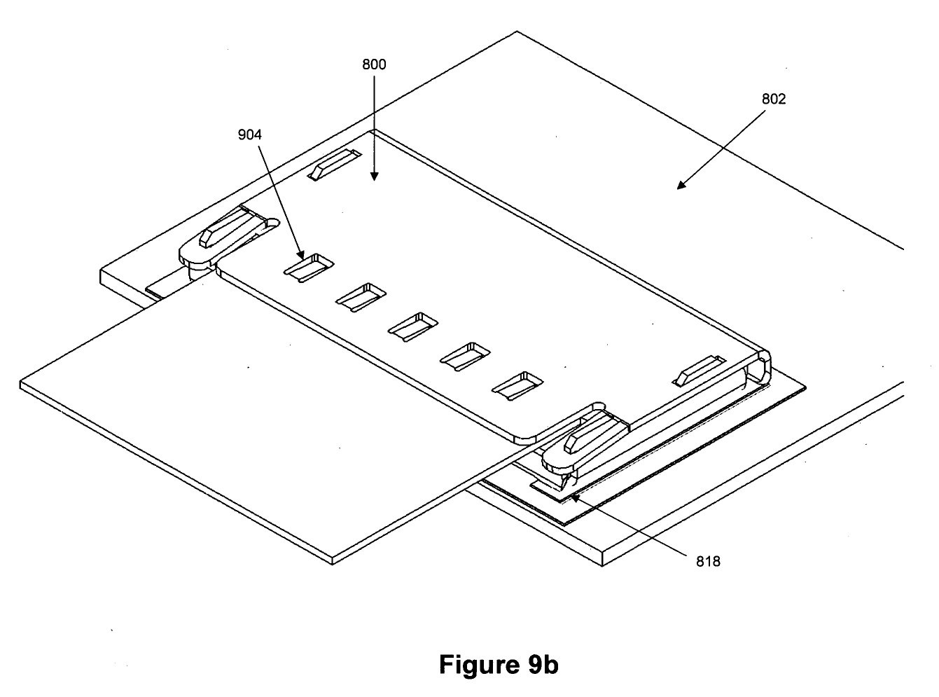

FIGS. 9a and 9b illustrate a FFC connector with grounding means 902 to the FFC 900. The illustration shows an array connector but the design is applicable to any FFC connector of one row, two rows, or multiple rows. The grounding means is also applicable to non-FFC connectors where grounding and/or shielding is desired. Clip 800 is mechanically and electrically connected to traces in circuit board 802 through strips 818. The mechanical connection holds the FFC connector in alignment with pads or traces on circuit board 802. This electrical path is typically used to ground a shield layer 902 exposed in cable 900. Alternately, this electrical path can be used for other signals or voltage supply. Additionally, the illustrations show optional grounding tabs 904 in clip 800 to provide multiple and controlled contact force across shield layer 902. Grounding of layer 902 in cable 900 can provide an RF or EMI shield across the entire connection system through the cable 900 connection at its opposite end. Another advantage of grounding layer 902 is to improve the electrical performance of cable 900 by controlled impedance. The typical application allows for industry standard designs known as micro-strip or strip-line circuits. FIG. 9b shows clip 800 in its closed position providing alignment of the cable to the connector, providing force to maintain electrical connection of the connector to the cable pads and grounding of cable 900 through a full path to circuit board 802.

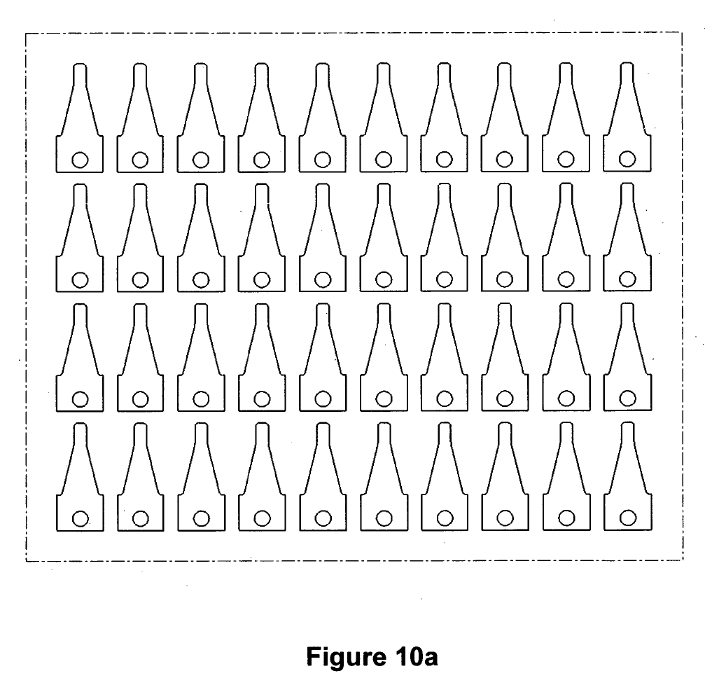

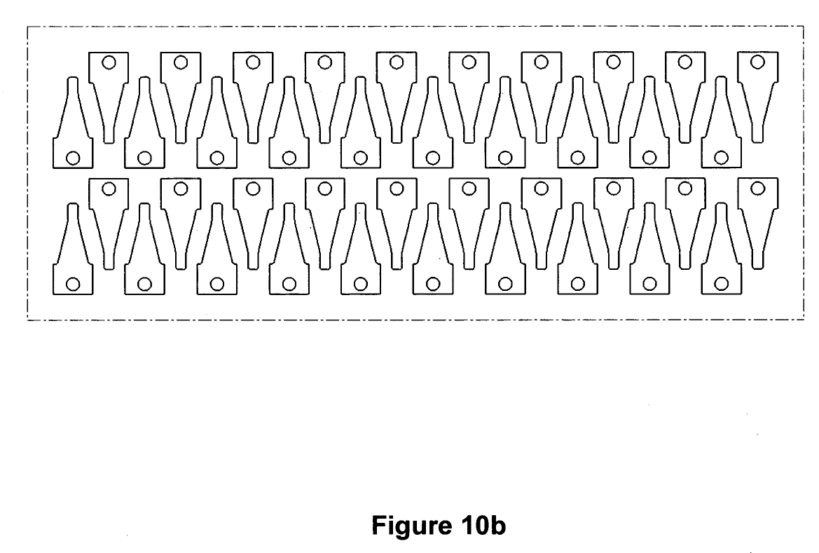

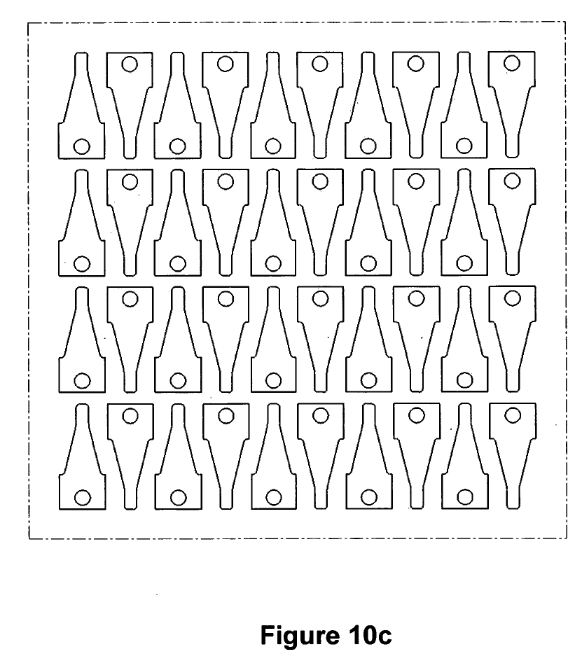

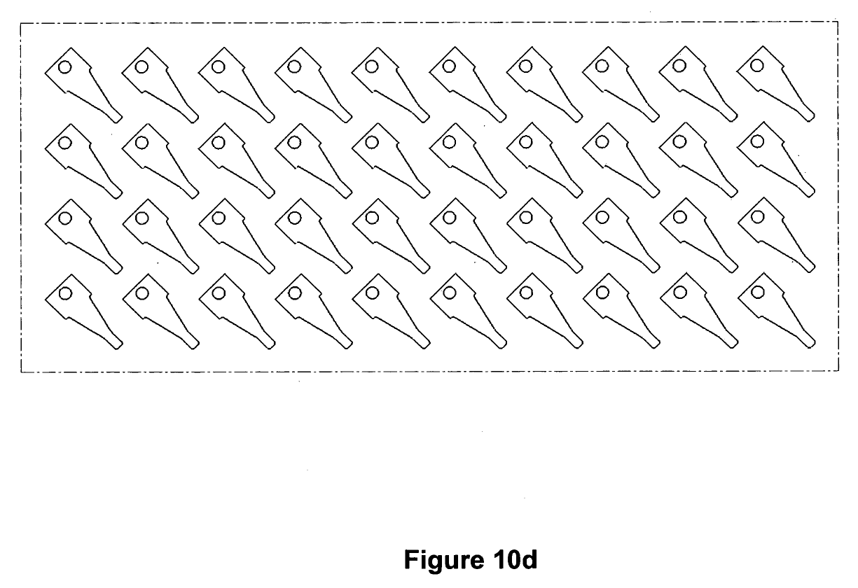

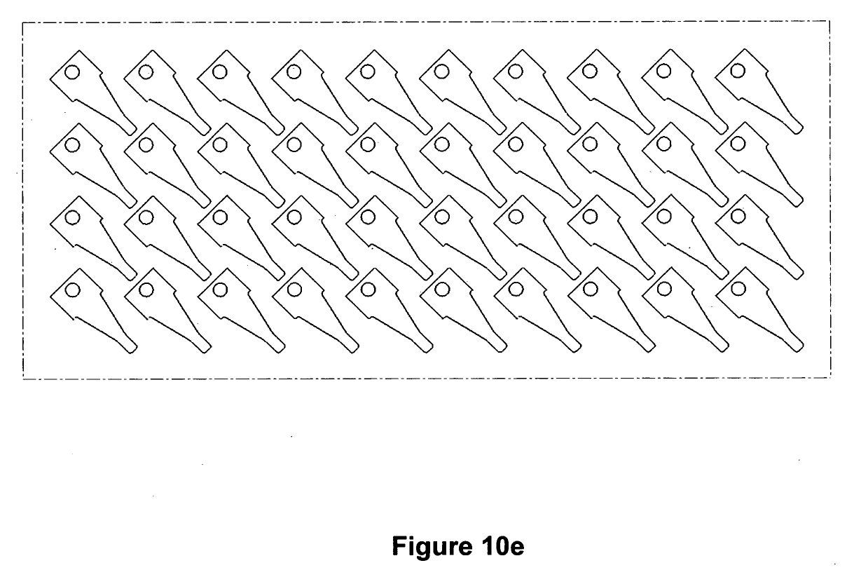

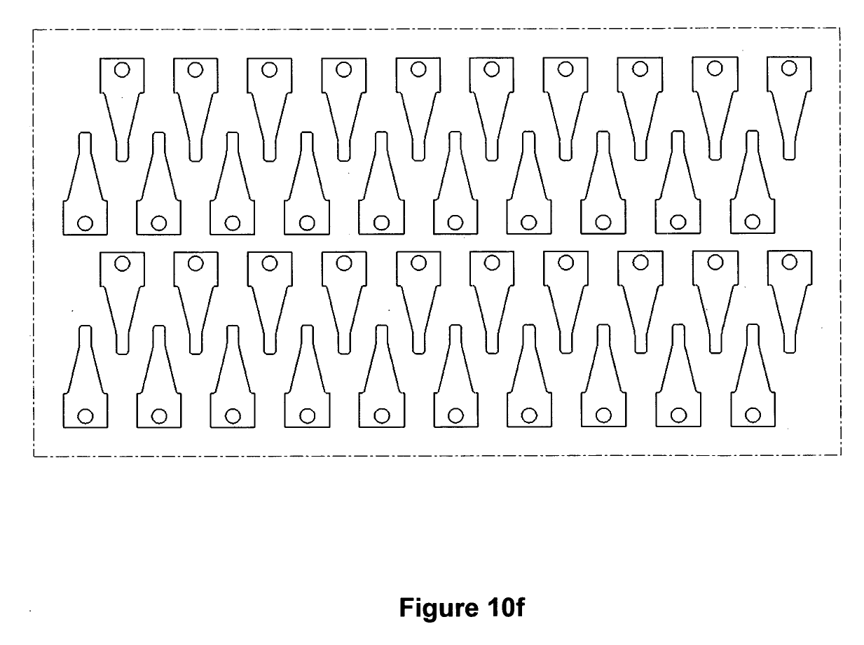

FFC connectors of the present invention allow for high density contact arrays within a connector using arrangement such as those illustrated in FIGS. 10a to 10f. While FIGS. 10a to 10f illustrate various configurations of a four-row array, any number of rows with different numbers of contacts per row can be used in the present invention. Likewise, orientation of the contacts can be optimized to allow for high-density arrays and contacts in a single row need not be oriented in the same direction within the row or in the same direction as contacts in other rows. Contact arrays of the present invention can be made by the methods described in “Method and System for Batch Manufacturing of Spring Elements,” of Dirk Brown et al., filed on Apr. 18, 2007; one such method is described in detail below.

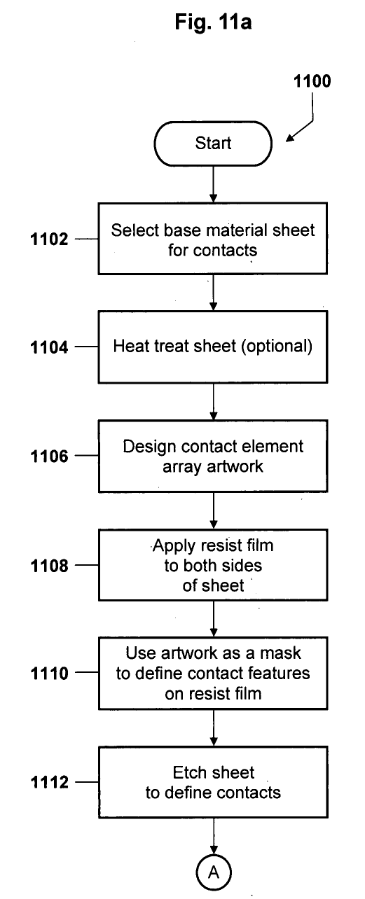

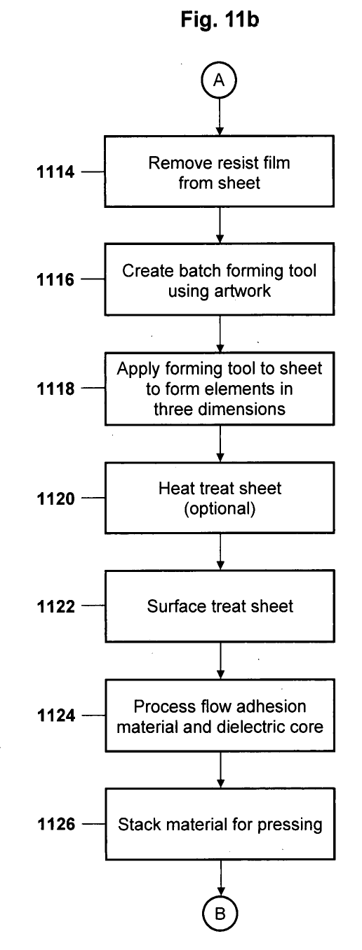

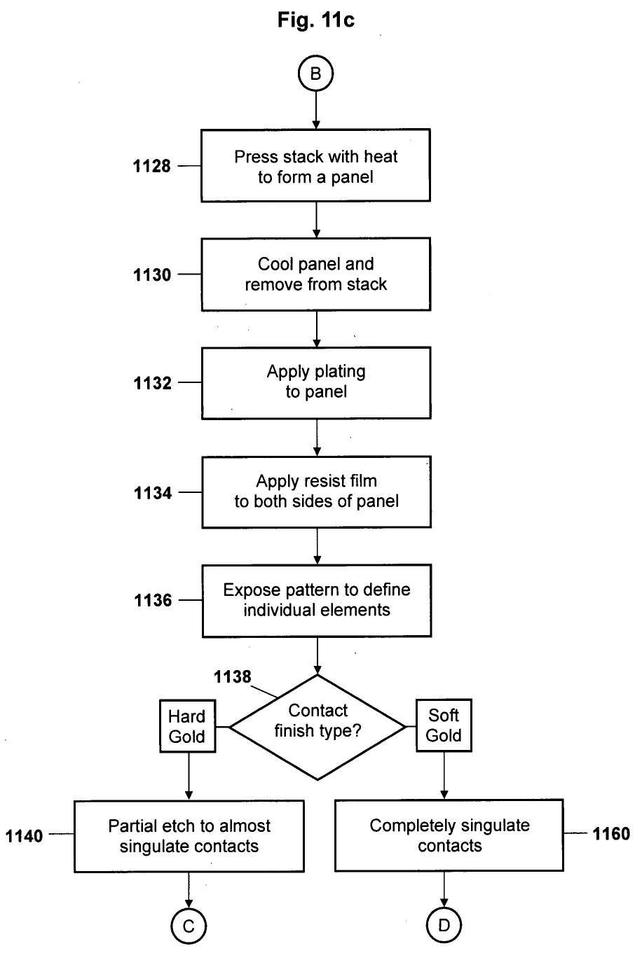

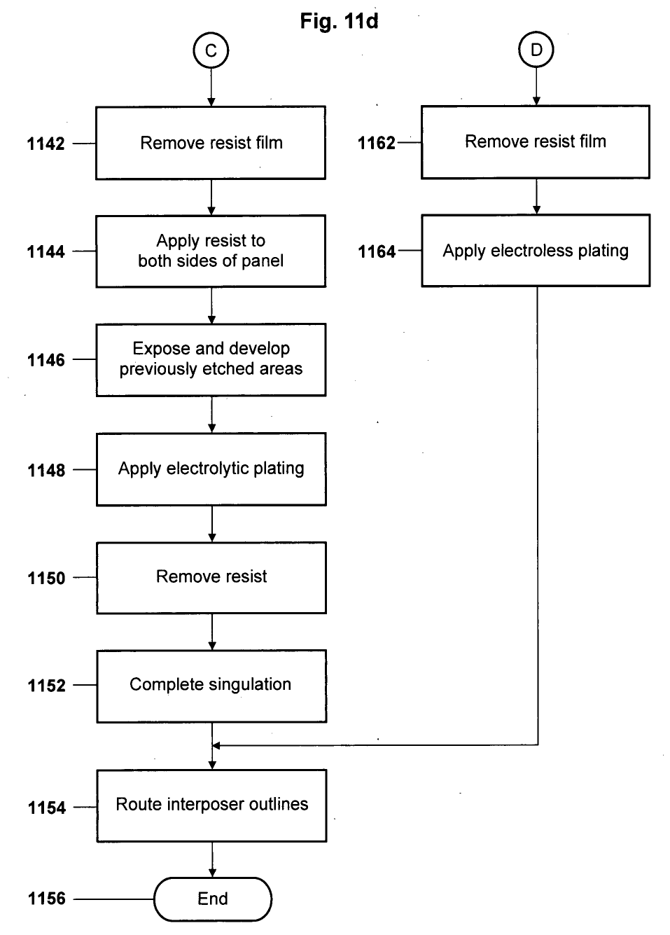

FIGS. 11a to 11d are flowcharts of a method 1100 for forming contact elements in accordance with one configuration of the present invention. The method 1100 also relates to batch fabrication of the contact elements using masking, etching, forming, and lamination techniques. The method 1100 produces a plurality of highly engineered electrical contacts, capable of use in a FFC connector. However, rather than using additional masking and etching steps to form the three dimensional spring portions, they are created in flat arrays and are then formed into three dimensional shapes.

First, a base spring material for the sheet of contacts is selected, such as beryllium copper (Be—Cu), spring steel, phosphorous bronze, or any other material with suitable mechanical properties (step 1102). The proper selection of material enables the contact elements to be engineered to have the desired mechanical and electrical properties. One factor in the selection of the base material is the working range of the material. Working range is the range of displacement over which the contact element meets both contact force (load) and contact resistance specifications. For example, assume that the desired contact resistance is less than 20 milliohms and the maximum allowed contact load is 40 grams. If the contact element reaches a resistance range of less than 20 milliohms at 10 grams of load and then is carried over to the maximum load of 40 grams for the beam member, while maintaining a resistance of less than 20 milliohms, then the distance over which the contact element has traveled between 10 grams and 40 grams of load would be the working range of the contact.

The sheet can be heat treated prior to subsequent processing (step 1104). Whether the sheet is heated at this point in the process is determined by the type of material selected for the sheet. The heating is performed to move the material from a half-hard state into a hard state or highly-tensile state that provides desired mechanical properties for forming the contacts.

A contact element is designed and is copied into an array form, for use in batch processing (step 1106). The number of contacts in an array is a design choice, and can vary depending on the requirements for the connector. The arrays are repeated into a panel format, analogous to chips or die in a semiconductor wafer, resulting in a scalable design that lends itself to batch processing. After the contact design has been completed (usually in a CAD drawing environment), the design is ported to a Gerber format, which is a translator that enables the design to be ported to a fabrication facility to produce the master slides or film to be used in the subsequent steps.

The panel format can have anywhere between one and a large number of contacts, because the use of lithography permits placing a high density of contacts onto a panel. This high density of contacts provides an advantage over existing methods in that a batch process can be used to singulate the contacts, as opposed to stamping and forming individual contacts. The method 1100 permits a large number of contacts to be patterned, developed, and etched at once.

A lithographically sensitive resist film is then applied to both sides of the sheet (step 1108). A dry film can be used for larger feature sizes ranging from one to 20 mils, and a liquid resist can be used for feature sizes less than one mil.

Using the artwork defined in step 1106, both the top and bottom of the sheet are exposed to ultraviolet (UV) light and then developed to define contact features in the resist (step 1110). Portions that are intended to be etched are left unprotected by the mask. Using a lithographic process to define the contact elements enables the printing of lines with a fine resolution, similar to that found in semiconductor manufacturing.

The sheet is then etched in a solution specifically selected for the material being used (step 1112). Each particular material that can be selected for the sheet typically has a specific etch chemistry associated with it to provide the best etch characteristics, such as etch rate (i.e., how well and how fast the solution performs the etch). This is an important consideration in the context of throughputs. The etchant selected also effects other characteristics like the sidewall profile, or the straightness of a feature as seen in cross section. In the method 1100, chemicals common in the industry are used, such as cupric chloride, ferric chloride, and sulfuric hydroxide. Once etched, the protective layer of resist is removed in a stripping process, leaving the etched features in the sheet (step 1114).

A batch forming tool is designed, based upon the artwork defined in step 1106 (step 1116). In one configuration, the batch forming tool includes a plurality of ball bearings arranged into an array format, preferably by being set into an array of openings in a support surface. The ball bearings can be of different sizes, to apply different forces to the contacts, thereby imparting different mechanical characteristics to contacts on the same panel. The curvature of the ball bearings is used to push the flanges away from the plane of the sheet. Alternatively, mating female and male die press plates or a configurable press is used to push the flanges away from the plane of the sheet. The flanges of the contacts are then formed in all three axes by applying the forming tool to the sheet, to produce the desired contact elements in a batch process (step 1118).

The sheet can be heat treated to correct grain dislocations caused by the forming process (step 1120). As with step 1104, the heating step 1120 is optional, and is dependent upon the material selected for the sheet. Based upon the material and the size of the contacts to be defined on the sheet, heating may be performed to obtain the physical properties desired for optimal forming conditions.

The sheet can then be surface treated to enhance adhesion properties for a subsequent lamination process (step 1122). If there is inadequate adhesion, there is a propensity for the sheet to separate from a substrate or delaminate. Several methods for performing the surface treating can be used, including micro etching and a black oxide process. The micro etching is used to pit the surface of the sheet, effectively creating a greater surface area (by making the surface rough and cratered) to promote better adhesion. However, if the micro etching is not properly controlled, it can lead to damage on the sheet.

The black oxide process is a replacement process involving a self-limiting reaction in which an oxide is grown on the surface of the sheet. In this reaction, the oxygen diffuses only through a set thickness, thereby limiting the amount of oxide grown. The oxide has a rough surface in the form of bumps, which helps to promote adhesion. Either the micro etching or the black oxide processes can be used for the surface treatment step, and a preference for one process over the other is a design choice.

Prior to pressing, a low flow adhesion material can be processed with relief depressions or holes located beneath flange elements (step 1124). This is intended to prevent excess flow of material up on the flange during the lamination process. Should this flow happen, the contact properties may be altered, causing the contact element to be unsuitable for electrical and mechanical use. A dielectric core or substrate with exposed electrical traces on the surface or internal circuitry for connecting the spring contact elements on the top to contact pads on the bottom is prepared by methods known in the art.

The following list is a typical stack up generated for lamination pressing (step 1126). This arrangement can be altered to have the contact elements inserted as internal layers.
a. Layer 1 is a top press plate material
b. Layer 2 is a spacer material with a relief hole over the spring contact element
c. Layer 3 is a release material with a relief hole over the spring contact
d. Layer 4 is a top sheet of formed contact sheets
e. Layer 5 is an adhesion material with a relief hole beneath the spring contact
f. Layer 6 is a core dielectric with either internal circuitry or exposed electrical traces to connect the spring contact elements to traces or pads on the bottom of the dielectric.
j. Layer 8 is a bottom press plate material

The stack up is pressed under temperature conditions optimized for desired adhesions and flow conditions for the adhesion material (step 1128). During this operation, the top contact sheet is bonded to a core dielectric material. After a cool down period, the stack up is removed from the press plates, leaving a panel comprised of Layers 4-6 (step 1130).

The panel surfaces are then plated to electrically connect the spring contact elements to the traces and/or pads on the bottom of the substrate (step 1132). This step involves a plating process known as an electroless process. The process effectively deposits a conductive material on the top surface of the traces and contact pads that effectively connects the traces to the base of the spring contact elements. The plating process creates a route for an electrical current to travel from one side of the board to the other.

Next, a photosensitive resist film is applied to side of the panel with the spring contact elements (step 1134). A pattern is exposed and developed to define the individual contact elements (step 1136). A determination is then made as to the contact finish type, either hard gold or soft gold (step 1138). Hard gold is used in specific applications where the numbers of insertions required are high, such as a test socket. Hard gold itself has impurities that cause the gold to be more durable. Soft gold is a pure gold, so it effectively has no impurities, and is typically used in the PCB or networking space, where the number of insertions is fairly low. For example, a package to board socket used in a PC (soft gold) will typically see on the order of one to 20 insertions, whereas other technology using hard gold will see a number of insertions between 10 and 1,000,000.

If the contact finish type is a hard gold, then a partial etching is performed to almost singulate the contact elements (step 1140). The resist film is removed via a stripping process (step 1142). A new layer of resist is applied, covering both sides of the panel (step 1144). The previously etched areas are exposed and developed (step 1146). The panel is then submitted for electrolytic Cu/Ni/Au plating via a hard gold process (step 1148).

The resist is removed to expose previous partially etched scribe lines (step 1150). The entire panel is etched using electrolytic Ni/Au as a hard mask to complete singulation of the contact array (step 1152). Final FFC connector outlines are routed out of the panel to separate the panel into individual connector arrays (step 1154), and the method terminates (step 1156).

If a soft gold finish is used (step 1138), then etching is used to completely singulate the contact elements (step 1160). The resist film is removed via a stripping process (step 1162). Electroless Ni/Au, also known as a soft gold, is plated onto the panel to complete the contact elements (step 1164). Final FFC connector outlines are routed out of the panel to separate the panel into individual connector arrays (step 1154), and the method terminates (step 1156).

The soft gold finishing process singulates the contacts prior to plating. Ni/Au will plate only on metal surfaces, and provides a sealing mechanism for the contact element. This helps to prevent potential corrosive activity that could occur over the system life of the contact, since gold is virtually inert. Singulation prior to plating is a means to isolate or encapsulate the copper contact with another metal, resulting in cleaner imaging and a cleaner contact, which has a low propensity for shorting.

In an alternate configuration of the present invention, contacts within an array can include heterogeneous contact elements, that is, contact elements having different operating properties. One example of a heterogeneous contact arrangement is an array of contacts whose contact arm length varies between contacts. For example, a contact array can comprise two mutually interspersed contact sub arrays in which every other contact have mutually the same contact arm length and adjacent contacts have differing contact arm length.

When the contact elements of the connector of the present invention are formed using fabrication processes such as those described in “Method and System for Batch Manufacturing of Spring Elements,” of Dirk Brown et al., filed on Apr. 18, 2007, contact elements having a variety of mechanical and electrical properties can be formed. In particular, the use of fabrication processing steps allows a connector to be built to include contact elements having different mechanical and/or electrical properties. Such fabrication processes nevertheless can be employed in conjunction with substrates, such as PCB substrates, to form elastic contact arrays having contact sizes larger than the typical micron or sub-micron sizes typical of present day semiconductor devices. For example, these processes can be used to form contact arrays on PCB-type substrates having array pitches in the range of about 10-100 microns, for example.

Thus, according to another aspect of the present invention, a connector of the present invention is provided with contact elements having different operating properties. That is, the connector includes heterogeneous contact elements where the operating properties of the contact elements can be selected to meet requirements in the desired application. In the present description, the operating properties of a contact element refer to the electrical, mechanical and reliability properties of the contact element. By incorporating contact elements with different electrical and/or mechanical properties, the connector of the present invention can be made to meet all of the stringent electrical, mechanical and reliability requirements for high-performance interconnect applications.

According to one aspect of the present invention, the following mechanical properties can be specifically engineered for a contact element or a set of contact elements to achieve certain desired operational characteristics. First, the contact force for each contact element can be selected to ensure either a low resistance connection for some contact elements or a low overall contact force for the connector. Second, the elastic working range of each contact element over which the contact element operates as required electrically can be varied between contact elements. Third, the vertical height of each contact element can be varied. Fourth, the pitch or horizontal dimensions of the contact element can be varied.

According to alternate aspects of the present invention, the electrical properties can be specifically engineered for a contact element or a set of contact elements to achieve certain desired operational characteristics. For instance, the DC resistance, the impedance, the inductance and the current carrying capacity of each contact element can be varied between contact elements. Thus, a group of contact elements can be engineered to have lower resistance or a group of contact elements can be engineered to have low inductance.

In most applications, the contact elements can be engineered to obtain the desired reliability properties for a contact element or a set of contact elements to achieve certain desired operational characteristics. For instance, the contact elements can be engineered to display no or minimal performance degradation after environmental stresses such as thermal cycling, thermal shock and vibration, corrosion testing, and humidity testing. The contact elements can also be engineered to meet other reliability requirements defined by industry standards, such as those defined by the Electronics Industry Alliance (EIA).

When the contact elements in the connectors of the present invention are fabricated as a FFC connector, the mechanical and electrical properties of the contact elements can be modified by changing, for example, the following design parameters. First, the thickness of the curved spring portion of the contact element can be selected to give a desired contact force. For example, a thickness of about 30 microns typically gives low contact force on the order of 10 grams or less while a flange thickness of 40 microns gives a higher contact force of 20 grams for the same displacement. The width, length and shape of the curved sprint portion can also be selected to give the desired contact force.

Second, the number of curved spring portions to include in a contact element can be selected to achieve the desired contact force, the desired current carrying capacity and the desired contact resistance. For example, doubling the number of curved spring portions roughly doubles the contact force and current carrying capacity while roughly decreasing the contact resistance by a factor of two.

Third, specific metal composition and treatment can be selected to obtain the desired elastic and conductivity characteristics. For example, Cu-alloys, such as copper-beryllium, can be used to provide a good tradeoff between mechanical elasticity and electrical conductivity. Alternately, metal multi-layers can be used to provide both excellent mechanical and electrical properties. In one configuration, a contact element is formed using titanium (Ti) coated with copper (Cu) and then with nickel (Ni) and finally with gold (Au) to form a Ti/Cu/Ni/Au multilayer. The Ti can provide rigidity and high mechanical durability while the Cu can provide excellent conductivity as well as elasticity and the Ni and Au layers can provide excellent corrosion resistance. Finally, different metal deposition techniques, such as plating or sputtering, and different metal treatment techniques, such as alloying, annealing, and other metallurgical techniques can be used to engineer specific desired properties for the contact elements.

Fourth, the curvature of the curved spring portion can be designed to give certain electrical and mechanical properties. The height of the curved spring portion, or the amount of projection from the base portion, can also be varied to give the desired electrical and mechanical properties.

A great deal of contact design flexibility is afforded by the fact that two dimensional contact design is accomplished by well established computer-aided design. In other words, a mask or patterning process to form a desired contact structure can be designed using Gerber or other systems. Custom design can be performed or contact shapes can be selected from design libraries. Similarly, forming tools can be easily fabricated using designs that are matched to the contact array design of the spring sheet array to be formed. The lithographic techniques used for patterning spring sheets and/or forming tools are robust and inexpensive.

The mechanical properties of the elastic contacts can be further tailored by engineering of the adhesive layer during the bonding process. Adhesive layers suitable for configurations of the present invention typically contain a polymer inner layer surrounded by epoxy layers on top and bottom. It has been experimentally determined that proper choice of adhesive layer can increase working range by about 0.5-1 mil for contacts having a working range on the order of 6-8 mils. In addition, by providing adhesive reservoirs acting as flow restrictors, in the substrate or spring sheet superior contact properties are obtained after bonding. By proper design of such flow restrictors, the adhesive flow can be minimized. By preventing adhesive from flowing to the underside of a contact arm during bonding of a spring sheet, the flow restrictors facilitate fabrication of contact arms having a longer effective length. In other words, the point about which the contact arm rotates during downward displacement is effectively shorter when adhesive is located on the underside of the contact arms near the contact base. By ensuring no adhesive is located under the contact arm, thus extending the effective contact arm length, a greater displacement of a contact arm for a given load (stress) occurs, thereby reducing the possibility that the contact arm is subject to a yield stress before it reaches its maximum displacement.

Using the fabrication processes of the present invention, a contact array with a larger working distance can be fabricated. In applications in which reversible contact of the FFC to an FFC connector is desired, the additional ability to provide a more favorable contact element aspect ratio for a given array pitch affords a greater “reversible working range.” The term “reversible working range” refers to a range (such as a distance range) through which a FFC spring contact (or contact array) can be reversibly displaced while meeting specified criteria for performance, such as electrical conductivity, inductance, high frequency performance, and mechanical performance (such as a requirement that external applied force be below a certain value). Reversibility denotes that the working range of the contact (array) is preserved when the contact arms of the contact array are brought into contact with a FFC, compressed, released from contact, and subsequently brought back into contact with a FFC connector. Thus, a contact having a reversible working range of about 10 mil would maintain acceptable properties, such as conductivity and inductance, throughout a distance of 10 mil while being compressed and released repeatedly.

The working range or reversible working range of elastic contacts arranged in an array can be further expressed in terms of the pitch of the array. Configurations of the present invention provide FFC connectors whose array pitch and contact size are generally scalable from an array pitch of about 50 mils down to an array pitch of microns or less. In other words, the processes for making the contact arrays and via arrays can be scaled down from current technology (˜0.5-2 mm pitch) at least by a factor of 10-100. Accordingly, as the contact array pitch decreases, contact size and working range may decrease. For a given array pitch, the normalized working range is defined as the working range divided by the pitch. The normalized working range is similar to the elasticity to size ratio mentioned above. However, the former parameter refers to a ratio of an elastic displacement range of a contact arm as compared to the length (size) of the elastic contact arm, whereas the normalized working range is a measure of the relative displacement range of elastic contacts (in which properties of interest are acceptable) as compared to the space between contacts (pitch). Because configurations of this invention provide elastic contacts whose length can exceed the array pitch, the vertical range of displacement of a contact arm (equal to the working range at the limit) can attain a large fraction of the size of the array pitch. For example, if a contact arm at rest above the substrate forms an approximate 45 degree angle viewed in cross section, the height of the distal end of the contact above the substrate is about 0.7 times its length. Accordingly, when the contact arm is brought into contact with an external component, its range of travel can approximate the value of 0.7 times the contact length before the contact arm encounters the substrate surface. In this case, if the contact arm length is designed to lie along an array diagonal (and has a length about a factor of 1.2-1.4 times the array pitch), the normalized displacement achievable (equivalent to an upper limit on the normalized working range) would be in the range of 0.8-1.0. In practical implementations of this invention, normalized working ranges between about 0.25 and at about 1.0 are possible.

According to another aspect of the present invention, the substrate on which the contacts elements are disposed in a FFC connector is circuitized to incorporate an electrical circuit connecting one or more contact elements to contact pads on the opposite side of the substrate. In some configurations, the electrical circuit includes surface mounted or embedded electrical components. By incorporating an electrical circuit coupled to one or more of the contact elements, the FFC connector of the present invention can be provided with improved functionality.

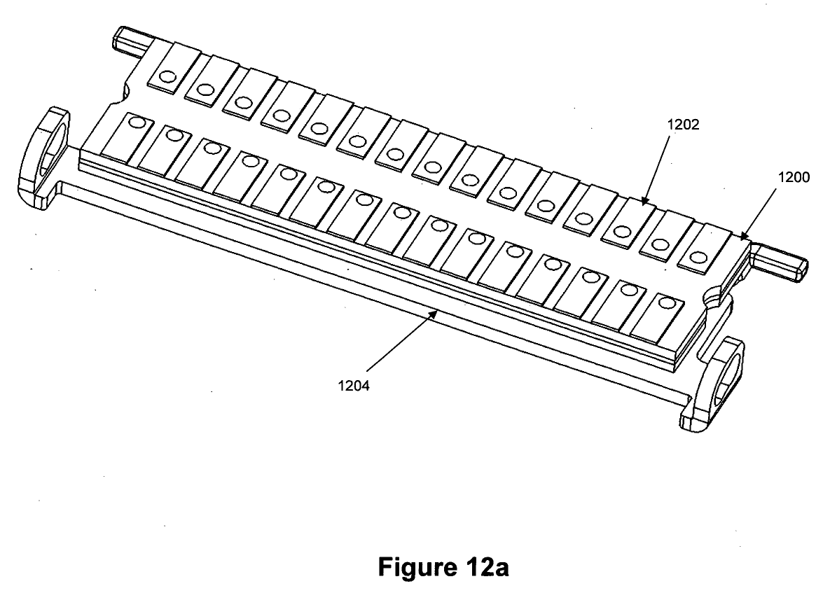

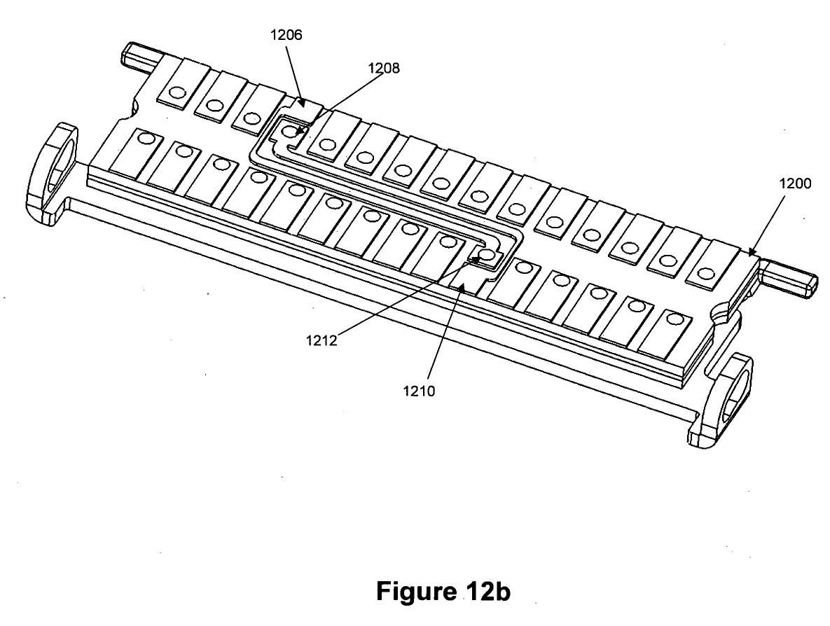

FIGS. 12a to 12b are shown to illustrate one configuration of a circuitized FFC connector in accordance with the present invention. FIG. 12a is a bottom-view of a substrate 1200 with contact pads 1202 resting on top of FFC connector lid 1204. Contact pads 1202 are mechanically and electrically connected to contact elements (not shown) on the opposite side of the substrate by traces or circuitry on or within the substrate. Contact pads 1202 when mounted in a FFC connector and on a circuit board make contact with the pads or electrical traces present on the board. FIG. 12b shows the cross-wiring of contact elements to different pads present on the bottom of a substrate. In this figure, contact pad portion 1206 is electrically connected to contact pad portion 1212 by circuitry present on the bottom (shown here) or within the substrate. Contact pad portion 1212 is also connected to a contact element on the opposite side of substrate 1200. Likewise, contact pad portion 1210 is electrically connected to contact pad portion 1208 by circuitry present on the bottom (shown here) or within the substrate. Contact pad portion 1208 is also connected to a contact element on the opposite side of substrate 1200. In this configuration, contact pad portions 1206 and 1210 make contact with respective pads or traces on a circuit board, while contact pad portions 1208 and 1212 are electrically isolated from the circuit board. This exemplary configuration allows the signal received by a contact element to be routed to a different pad on the opposite side of the substrate to which it is attached. It should be understood by one of ordinary skill in the art, that this configuration can be modified to connect any number of contact elements to different pads on the opposite side of a substrate and that other configurations can be achieved using circuitry embedded on or within the substrate.

1. A system for connecting a flat flexible cable with electrical traces to a circuit board, comprising:
spring contact elements on a substrate;
a clamp mounted on a circuit board for securing a flat flexible cable to spring contacts on the substrate;
exposed electrical traces on an end of the flat flexible cable;
the clamp further comprising an alignment mechanism for aligning at least one exposed electrical trace on the flat flexible cable with at least one spring contact element;
the flat flexible cable electrically connected to a least one spring contact on the substrate; and
the at least one spring contact element electrically connected to the circuit board.

2. The system of claim 1, further comprising an array of spring contact elements with more than one row of contacts.

3. The system of claim 1, further comprising spring contact elements arranged in different orientations.

4. The system of claim 1, further comprising a lid on the clamp with a locking mechanism for securing the clamp.

5. The system of claim 1, further comprising the alignment mechanism with at least one dowel pin for aligning the at least one exposed electrical trace on the flat flex cable with the at least one spring contact element.

6. The system of claim 1, further comprising providing grounding of the flat flex cable to the circuit board.

7. The system of claim 6, further comprising an electrically compliant ground plane.

8. The system of claim 1, further comprising heterogeneous spring contact elements.

9. The system of claim 1, further comprising a circuitized flat flexible cable.

10. The system of claim 1, further comprising spring contact elements electrically connected to contact pads on the opposite side of the substrate on which the spring contact elements are disposed.

11. The system of claim 1, further comprising spring contact elements with a normalized working range between about 0.25 and 1.0.

12. An clamp on a circuit board for connecting flat flexible cable comprising:
spring contacts mounted on a substrate in electrical contact with one or more circuits of the board's circuitry;
the substrate mounted within the clamp;
exposed traces on at least one end of the flat flexible cable; and
a device to align one or more exposed electrical traces on the flat flexible cable with one or more spring contacts within the clamp.

13. The clamp of claim 12 further comprising a lid on the clamp to secure the flat flexible cable within the clamp.

14. The clamp of claim 12 further comprising an alignment mechanism to register the exposed traces of the flat flexible cable with spring contacts within the clamp.

15. The clamp of claim 12 further comprising dowel pins to align the exposed electrical traces on the flat flexible cable to the spring contacts on the circuit board.

16. The clamp of claim 12 further comprising heterogeneous spring contacts.

17. The clamp of claim 12 further comprising a ground for the spring contacts.

18. The clamp of claim 17, further comprising an electrically compliant ground plane. The clamp of claim 12, further comprising spring contact elements with a normalized working range between about 0.25 and 1.0.
